(19) United States
(12) Patent Application Publication
(10) Pub. No.: US 2008/0098093 A1
(43) Pub. Date: Apr. 24, 2008

(54) OFFLINE AUTOMATED PROXY CACHE FOR WEB APPLICATIONS

(75) Inventors: Gregory R. Simon, San Francisco, CA (US); Manjirnath Chatterjee, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Palm, Inc., Sunnyvale, CA (US)

(21) Appl. No.: 11/873,305

(22) Filed: Oct. 16, 2007

Related U.S. Application Data
(60) Provisional application No. 60/829,645, filed on Oct. 16, 2006.

(51) Int. Cl. G06F 15/16

(52) U.S. Cl. 709/219

(57) ABSTRACT

Embodiments of the present invention provide techniques for managing content updates for web-based applications. In one set of embodiments, a configurable proxy cache is provided that executes rule-based content updates of web content on the behalf of an application (e.g., web browser) while the application is not running. This allows for better management of intermittent connection quality, memory/power savings for mobile devices, and caching of information that can be shared with the application and other network-aware applications/services. In various embodiments, the proxy cache is controlled by the application via standard web language constructs such as HTTP headers, thereby enabling interoperability with web-based applications that implement common asynchronous data-loading technologies.

### CROSS-REFERENCES TO RELATED APPLICATIONS

This application claims the benefit of U.S. Provisional Application No. 60/829,645, filed Oct. 16, 2006 by Simon et al. and entitled “Offline Automated Proxy Cache for Web Applications,” the disclosure of which is incorporated herein by reference in its entirety for all purposes.

### BACKGROUND OF THE INVENTION

Embodiments of the present invention relate to computer networking, and more particularly relate to techniques for managing content updates for web-based applications.

In recent years, many web-based applications have been developed that take advantage of asynchronous data-loading techniques (e.g., AJAX, FLEX, etc.). These techniques (typically implemented using a combination of technologies such as HTML, XHTML, XML, JavaScript, ECMAScript, CSS, Macromedia® Flash®, etc.) enable an application to dynamically update portions of a web page without requiring a reload of the entire page. For example, a typical sports-related web page may include a dynamic score ticker. When the web page is loaded using a client web browser, a script or other small program (e.g., JavaScript, ECMAScript, etc.) may be run by the browser that retrieves the latest scores on a periodic basis. As the latest scores are retrieved, the score ticker is updated in the browser accordingly (without refreshing/reloading the web page). In this manner, data updates are limited to the content that is actually changed (e.g., score information), rather than encompassing the contents of the entire web page, thereby reducing used bandwidth. Additionally, the perceived interactivity and responsiveness of the application may be improved.

One limitation with the asynchronous data loading techniques described above is that they require the client application (e.g., web browser) to be running in order for data updates to take place. For example, in the case of the sports web page described above, the client web browser must be running in order for the embedded script to download additional, updated scores. This poses a problem in situations where the application/browser must be periodically closed/shut down. For example, handheld/mobile devices such as cellular phones, personal digital assistants (PDAs), mobile PCs, and the like typically have limited memory or battery power, making it difficult to have a large application such as a web browser continuously running. In these situations, data updates cannot be downloaded when the application/browser is closed. Additionally, since the updates are not downloaded, they cannot be stored for later use. Thus, if the application/browser is re-launched at a time when network connectivity is unavailable (e.g., on an airplane), it is not possible to display the most recent information or information that was recent as of the last time network connectivity was available.

One solution to the above limitation is to create a standalone program that runs while the original application/browser is disabled and retrieves content updates on behalf of the original application/browser. For example, Gmail Notifier (developed by Google) is a standalone application that periodically polls a user's Gmail account for new email messages (even when the user's web browser is closed) and notifies the user accordingly. However, such programs are necessarily tied to the original applications they are designed to work with/on behalf of, and cannot be generically used to retrieve content updates for the large number of web-based applications that use standard, asynchronous data loading techniques as described above.

Thus, it would be desirable to have configurable mechanisms for automatically downloading content updates for an application while the application is not running. Further, it would be desirable if these mechanisms were interoperable with web-based applications that implement standard, asynchronous data-loading techniques such as AJAX.

### BRIEF SUMMARY OF THE INVENTION

Embodiments of the present invention provide techniques for managing content updates for web-based applications. In one set of embodiments, a configurable proxy cache is provided that executes rule-based content updates of web content on the behalf of an application (e.g., web browser) while the application is not running. This allows for better management of intermittent connection quality, memory/power savings for mobile devices, and caching of information that can be shared with the application and other network-aware applications/services. In various embodiments, the proxy cache is controlled by the application via standard web language constructs such as HTTP headers, thereby enabling interoperability with web-based applications that implement common asynchronous data-loading technologies.

According to one embodiment of the present invention, a first request for data is received from an application, where the first request includes one or more configuration parameters, and where the one or more configuration parameters define a schedule for retrieving the data from a remote server. The data is then retrieved from the remote server according to the schedule, where the step of retrieving is performed while the application is not running.

In further embodiments, the step of retrieving the data from the remote server according to the schedule includes forwarding, at a time indicated in the schedule, the first request to the remote server; receiving the data from the remote server in response to the forwarding of the first request; and storing the data in a cache.

In further embodiments, a second request for the data is received from the application, and the data stored in the cache is transmitted to the application in response to the second request.

In various embodiments, the one or more configuration parameters may include a history parameter defining a maximum number of versions of the data that may be stored in the cache simultaneously; a time interval parameter defining a time interval at which the data is to be retrieved from the remote server; a retry parameter defining a number of times to retry a connection to the remote server; and/or a notification parameter indicating that a notification should be transmitted to the application upon occurrence of an event.

In various embodiments, the application may be a web browser or any other type of application that utilizes standard web language constructs for network communication. In one set of embodiments, the first request is an HTTP request, and the one or more configuration parameters correspond to one or more HTTP headers.

According to another embodiment of the present invention, a first request for data is received from an application, where the first request includes an identifier that uniquely identifies the first request. In one embodiment, the identifier corresponds to a proxy session ID that is used to retrieve the data that is cached in response to the first request. In various embodiments, the first request is forwarded to a remote server, and the requested data is received from the remote server in response to the forwarding the first request. The received data and the identifier is stored in a cache. A second request for the data is then received from the application, where the second request includes the identifier. In various embodiments, the data is retrieved from the cache using the identifier and is transmitted to the application in response to the second request.

According to another embodiment of the present invention, a configurable proxy is provided. The configurable proxy includes a request processing component configured to receive, from a client application, a request for data, and detect the presence of one or more proxy configuration parameters within the request. The configurable proxy further includes a rules component configured to determine a schedule for retrieving the requested data from a remote server based on the one or more proxy configuration parameters, and repeatedly forward the request to the remote server according to the determined schedule without further requests from the client application. In various embodiments, the configurable proxy may also include a data storage component configured to cache data received from the remote server for later transmission to the client application.

In one set of embodiments, the configurable proxy is implemented as a software application running on a computing device such as a mobile or handheld device. In further embodiments, the configurable proxy is run on the same device as the client application.

According to another embodiment of the present invention, a system for managing content updates comprises a first computing device configured to execute a first client application and a first proxy application. The first proxy application is configured to receive, from the first client application, a first request for first data, where the first request includes one or more configuration parameters, and where the one or more configuration parameters define a first schedule for retrieving the first data from a remote server; and retrieve the first data from the remote server according to the first schedule, where the step of retrieving is performed while the first client application is not running. In various embodiments, the first computing device is a mobile or handheld device.

In further embodiments, the system further includes a second computing device configured to execute a second client application and a second proxy application. The second proxy application is configured to receive, from the second client application, a second request for second data, where the second request includes one or more configuration parameters, and where the one or more configuration parameters define a second schedule for retrieving the second data from the remote server; and retrieve the second data from the remote server according to the second schedule, where the step of retrieving is performed while the second client application is not running. In various embodiments, the system further includes a third computing device communicatively coupled with the first and second computing devices, where the third computing device is configured to execute a shared proxy application, and where the first and second proxy applications are configured to access the remote server through the shared proxy application.

According to another embodiment of the present invention, a machine-readable medium for a computer system is disclosed. The machine-readable medium has stored thereon a series of instructions which, when executed by a processing component, cause the processing component to receive from an application a first request for data, where the first request includes one or more configuration parameters, and where the one or more configuration parameters define a schedule for retrieving the data from a remote server; and retrieve the data from the remote server according to the schedule, where the step of retrieving is performed while the application is not running.

A further understanding of the nature and the advantages of the embodiments disclosed herein may be realized by reference to the remaining portions of the specification and the attached drawings.

### BRIEF DESCRIPTION OF THE DRAWINGS

Various embodiments in accordance with the present invention will be described with reference to the drawings, in which:

FIGS. 1A and 1B are flowcharts of a first technique for managing content updates for an application in accordance with an embodiment of the present invention.

FIG. 2 is a flowchart of a second technique for managing content updates for an application in accordance with an embodiment of the present invention.

FIG. 3 is a simplified block diagram of a proxy in accordance with an embodiment of the present invention.

FIG. 4 is a simplified block diagram of a first system environment that may be used in accordance with an embodiment of the present invention.

FIG. 5 is a simplified block diagram of a second system environment that may be used in accordance with an embodiment of the present invention.

FIG. 6 is a simplified block diagram of a computing device that may be used in accordance with an embodiment of the present invention.

### DETAILED DESCRIPTION OF THE INVENTION

In the following description, for the purposes of explanation, numerous specific details are set forth in order to provide an understanding of the present invention. It will be apparent, however, to one skilled in the art that the present invention may be practiced without some of these specific details. In other instances, well-known structures and devices are shown in block diagram form.

Embodiments of the present invention provide techniques for managing content updates for web-based applications. According to one set of embodiments, a configurable proxy cache runs as an intermediary between a client application (e.g., web browser or other web-based program) and downstream network software/servers, and is controlled by standard web language constructs (e.g., HTTP headers). The web language constructs, which correspond to configuration parameters, enable the proxy cache to retrieve content updates on behalf of the application in a structured manner, even when the application is not running. In specific embodiments, the parameters define a schedule for managing content updates. Embodiments of the present invention do not require a client-side web server or the use of server-side scripting languages such as PHP, Perl/CGI, Python, Java or the like.

In some embodiments, the proxy cache may be configured to run on the same device as the client application. In alternative embodiments, the proxy cache may be configured to run on a separate device. In these alternative embodiments, the proxy cache may act as a shared proxy and have its cached data shared among multiple client devices/computers in a network.

In one set of embodiments, the configuration parameters include a session proxy identifier that uniquely identifies a particular data request from an application. The session proxy identifier is stored with the results of the data request in the proxy cache. In various embodiments, the session proxy identifier may be submitted by the application in subsequent requests to retrieve the data stored with the identifier in the proxy cache.

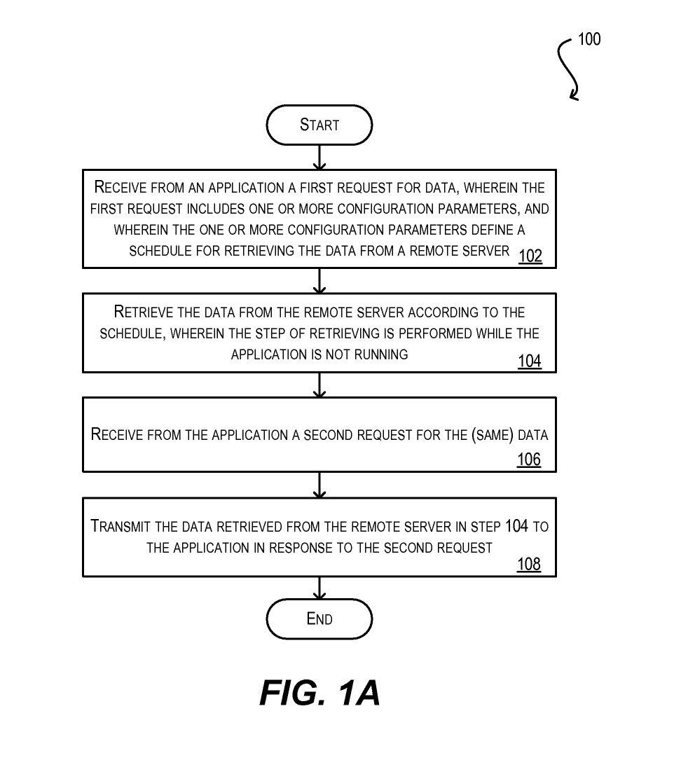

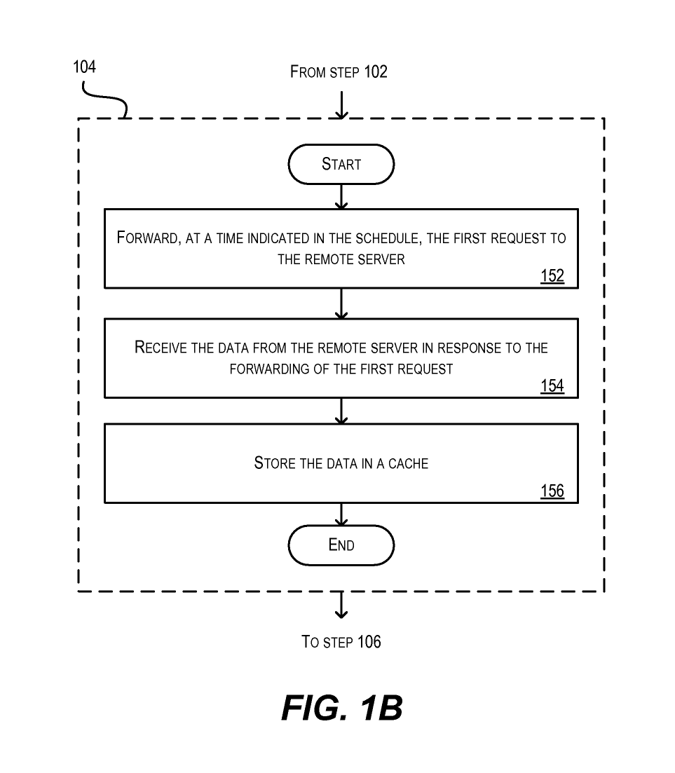

FIGS. 1A and 1B illustrate a flowchart 100 of a first technique for managing content updates for an application in accordance with an embodiment of the present invention. Using this technique, content updates may be scheduled and performed while the application is not running. The processing of flowchart 100 may be implemented in software, hardware, or combinations thereof. As software, embodiments of flowchart 100 may be implemented, for example, as a proxy application. Further, the software may be stored on a machine-readable medium. As hardware, embodiments of flowchart 100 may be, for example, programmed into one or more field-programmable gate arrays (FPGAs) or fabricated as one or more application-specific integrated circuits (ASICs). One of ordinary skill in the art would recognize many variations, modifications, and alternatives.

At step 102, a first request for data is received from an application. In various embodiments, the application is a web-based application (e.g., web browser or other program capable of communicating via standard web protocols), and the first request is an HTTP request destined for a remote web server. The first request includes one or more configuration parameters set by the application, where the parameters define a schedule for retrieving the data from the remote server. The configuration parameters may include, for example, a time interval parameter that defines a time interval for requesting data updates from the remote server. As will be described in detail below, other types of configuration parameters are contemplated and within the scope of the present invention. In one embodiment, the configuration parameters are represented as HTTP header name-value pairs. In other embodiments, the configuration parameters may be represented using any other standard web language construct.

Once the first request is received, the first request is forwarded to the remote server and a response is transmitted to the application. In addition, the configuration parameters are used to determine a schedule for requesting future updates of the data from the remote server. Based this schedule, the data is retrieved from the remote server on a periodic basis in an automated fashion (step 104). In various embodiments, this step may be performed while the application is not running. For example, the application may have been shut down by the application user, or closed unexpectedly. Thus, updated versions of the content requested in the first request may be automatically retrieved on the application's behalf while the application is down or offline.

As shown in FIG. 1B, step 104 of FIG. 1A may include several sub-steps 152, 154, 156. At step 152, the first request is forwarded to the remote server at a time indicated in the schedule. In response to the forwarding of the first request, the requested data is received from the remote server (step 154). The data received in step 154 is then stored in a cache (step 156). In various embodiments, steps 152, 154, 156 may be repeated multiple times.

Returning to FIG. 1A, a second request for the data (i.e., the same data requested in step 102) may be received from the application after the application has been re-launched or brought back online (step 106). At step 108, the data retrieved from the remote server in step 104 (and stored in the cache) is transmitted to the application in response to the second request. If multiple versions of the data were retrieved from the remote server through multiple iterations of steps 152, 154, 156 of FIG. 1B, then the latest version may be returned to the application.

It should be appreciated that the specific steps illustrated in FIGS. 1A and 1B provide a particular method for managing content updates of an application according to an embodiment of the present invention. Other sequences of steps may also be performed according to alternative embodiments. For example, alternative embodiments of the present invention may perform the steps outlined above in a different order. Moreover, the individual steps illustrated in FIGS. 1A and 1B may include multiple sub-steps that may be performed in various sequences as appropriate to the individual step. Furthermore, additional steps may be added or removed depending on the particular applications. One of ordinary skill in the art would recognize many variations, modifications, and alternatives.

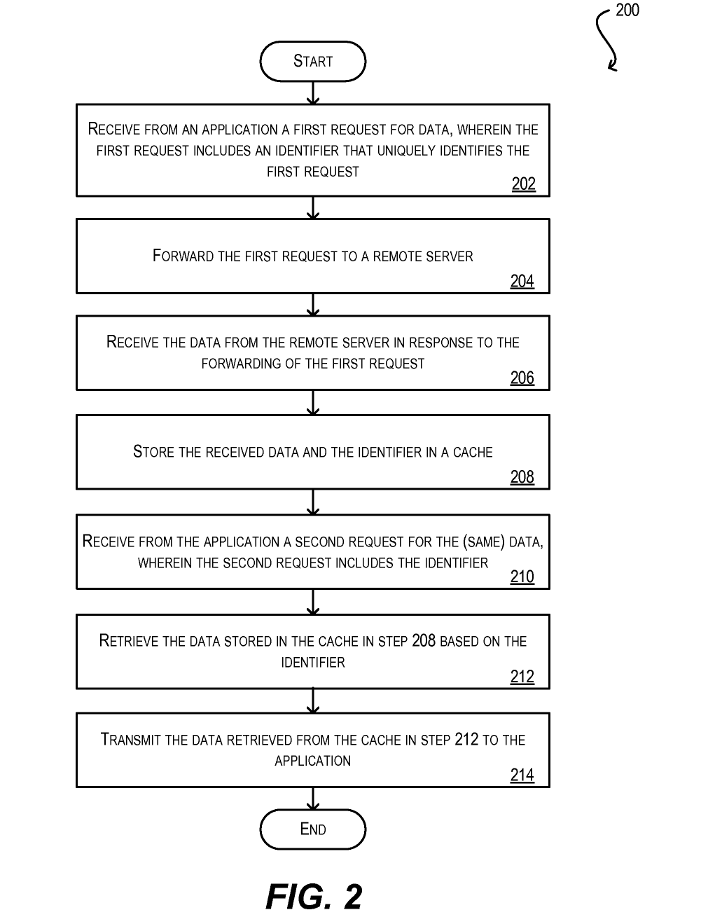

FIG. 2 illustrates a flowchart 200 of a second technique for managing content updates for an application in accordance with an embodiment of the present invention. Using this technique, an application may programmatically retrieve specific data updates that are cached by an external proxy while the application is offline. The processing of flowchart 200 may be implemented in software, hardware, or combinations thereof. As software, embodiments of flowchart 200 may be implemented, for example, as a proxy application. Further, the software may be stored on a machine-readable medium. As hardware, embodiments of flowchart 200 may be, for example, programmed into one or more field-programmable gate arrays (FPGAs) or fabricated as one or more application-specific integrated circuits (ASICs). One of ordinary skill in the art would recognize many variations, modifications, and alternatives.

At step 202, a first request for data is received from an application, where the first request includes an identifier that unique identifies the first request. In various embodiments, the identifier is referred to as a session proxy identifier.

At steps 204, 206, 208, the first request is forwarded to a remote server, and the requested data is received and stored, along with the identifier, in a cache. In one set of embodiments, steps 204, 206, 208 may be performed according to a content update schedule while the application is not running (as described with respect to FIG. 1). In other embodiments, steps 204, 206, 208 may be performed while the application is running/online.

A second request for the same data is then received from the application, wherein the second request includes the identifier (step 210). In response, the data stored in the cache in step 208 is retrieved based on the identifier, and the retrieved data is transmitted to the application (steps 212, 214). In this manner, the application may programmatically retrieve a piece of data that was cached in response to a previous data request.

It should be appreciated that the specific steps illustrated in FIG. 2 provide a particular method for managing content updates of an application according to an embodiment of the present invention. Other sequences of steps may also be performed according to alternative embodiments. For example, alternative embodiments of the present invention may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. One of ordinary skill in the art would recognize many variations, modifications, and alternatives.

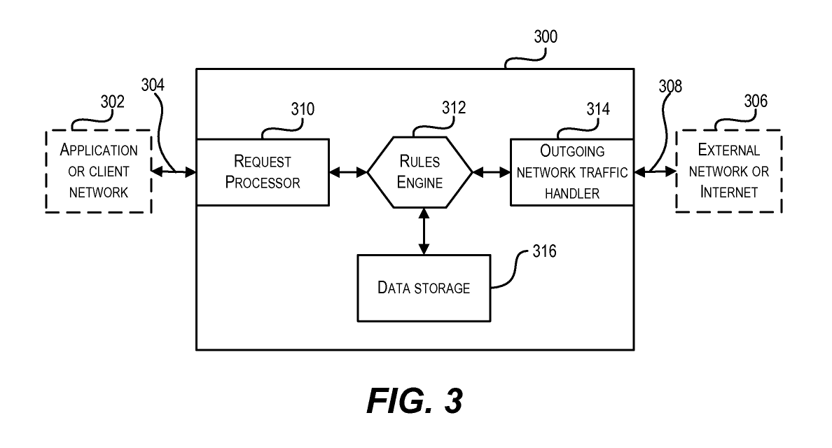

FIG. 3 is a simplified block diagram of a proxy cache 300 in accordance with an embodiment of the present invention. In various embodiments, proxy cache 300 may be used to carry out methods 100 and 200 described with respect to FIGS. 1A, 1B, and 2. Proxy cache 300 may be implemented in software, hardware, or combinations thereof. As software, embodiments of proxy cache 300 may be implemented, for example, as a standalone application. Alternatively, proxy cache 300 may be implemented as a plug-in to an existing application or as an operating system function/service. Further, the software may be stored on a machine-readable medium. As hardware, portions of proxy cache 300 may be, for example, programmed into one or more field-programmable gate arrays (FPGAs) or fabricated as one or more application-specific integrated circuits (ASICs). One of ordinary skill in the art would recognize many variations, modifications, and alternatives.

As shown, proxy cache 300 includes a request processor 310, a rules engine 312, an outgoing network traffic handler 314, and a data storage device 316. Request processor 310 is configured to receive data requests from a client application or client network 302 via network link 304. In various embodiments, the data requests include one or more configuration parameters designed to control the operation of proxy cache 300, and request processor 310 is configured to identify these configuration parameters. In one embodiments, the data requests are HTTP requests and the configuration parameters correspond to HTTP headers.

The request and identified configuration parameters are passed to rules engine 312, which is configured to forward the request to outgoing network traffic handler 314 for transmission to external network/server 306 (via network link 308). In one set of embodiments, the request is forwarded in an unaltered form. In other embodiments, the HTTP headers corresponding to the configuration parameters may be stripped from the request. Once results are received from external server 306 in response to the forwarding of the request, the results are cached in data storage device 316 and returned to client application 302.

In various embodiments, rules engine 312 is further configured to determine a content update schedule based on the configuration parameters and asynchronously forward the request to outgoing network traffic handler 314 (for transmission to external server 306) on a repeated basis according to the schedule. In various embodiments, this is performed independently of client application 302 (i.e., without receiving any further requests from client application 302). The results are received and cached in data storage device 316 and may be transmitted to client application 302 the next time application 302 submits a request for the same data. In this manner, a web-based application, using configuration parameters formatted as HTTP headers, may control proxy cache 300 to retrieve data updates while the application is not running, and then access the results when the application comes online. Application 302 may request to retrieve the information cached in data storage 316, or retrieve parameters about what happened during the time the application was not running.

Embodiments of the present invention produce programmatically controlled deterministic results to offline, deferred access which is not possible with a typical web browser cache or without having a web server to the process the request. Note that downstream servers may see the HTTP headers used to control proxy cache 300. However, through proper selection of HTTP header name value pairs, downstream servers may simply ignore these headers. This allows embodiments of the present invention to interoperate gracefully with existing web systems, without incurring additional design overhead or compatibility issues with existing web browsers, servers, or other web infrastructure.

The configuration parameters that may be used to control proxy cache 300 may include, but are not limited to, the following:

| Parameter | Description | Example |
|---|---|---|
| T | Time interval - the time interval to re-run | t = 60 m |
| | the request. The last character determines | |
| | the units (m = minutes; h = hours; s = seconds; | |
| | d = days). In one set f embodiments, if this | |
| | parameter is not present, the proxy cache | |
| | will not be (re)programmed (although it may | |
| | still return results to the client application). | |
| H | Cache history - Number of versions of a | H = 4 |
| | piece of data to keep in the cache. In | |
| | various embodiments, data are stored in a | |
| | first-in, first-out (FIFO) fashion. | |
| F | Force network connection - Erases cache | F |
| | entries and the scheduler entry. | |
| E | Data expiry - Specifies when the data in the | E = inf |
| | cache will expire. The last character may be | |
| | used to determine the unit of time | |
| | (m = minutes; h = hours; s = seconds; d = days; | |
| | inf = infinity). | |
| Ret | Retry - Number of retries to attempt a | Ret = 20 |
| | connection to the remote server (does not | |
| | include retries requested by the client | |
| | application directly). | |
| sT | Timing - Specifies a time at which to begin | sT = 2007.10.10:1600 |
| | offline content updates, including | |
| | passthrough and delayed update modes. | |
| maxSize | Size of updates - Specifies the maximum | maxSize = 3400 |
| | size, in bytes, for each data update. | |
| clear | Cache clear - Clears the cache and instructs | clear = 1 |
| | the proxy to obtain the requested data from | |
| | the remote server. May return a failure of | |
| | the network/server is unavailable. | |
| wake | Notify - May be used to send a wake/notify | Wake = app:iexplore.exe(param) |
| | event to the client application, including | |
| | instructions to load a specific web page. | |
| | This allows for a browser-based application | |
| | to be activated upon the occurrence of a | |
| | specific event (e.g. , receipt of a new email | |
| | message). | |
| Id | Session Proxy ID - A serial number for | Id = 12345678 |
| | retrieving specific proxy events. May be | |
| | generated by the client application or the | |
| | proxy cache. May be universally unique or | |
| | correspond to an application name/ID pair, | |
| | where the ID is unique within the | |
| | namespace of the application. | |
| conType | Attempts to run the proxy when network | conType = ‘gprs’ |
| | coverage is known to have a monetary cost | |
| | (e.g., over a cellular connection). | |

To use proxy cache 300 with existing web-based applications, application developers may simply add appropriate HTTP headers (corresponding to one or more of the configuration parameters above) to the HTTP requests generated by their applications. For example, the following JavaScript code may be used:

r=new XMLHttpRequest( );

. . .

r.setRequestHeader(‘X-WebVM-Schedule’, ‘t=60m,h=1’);

. . .

r.send( . . . );

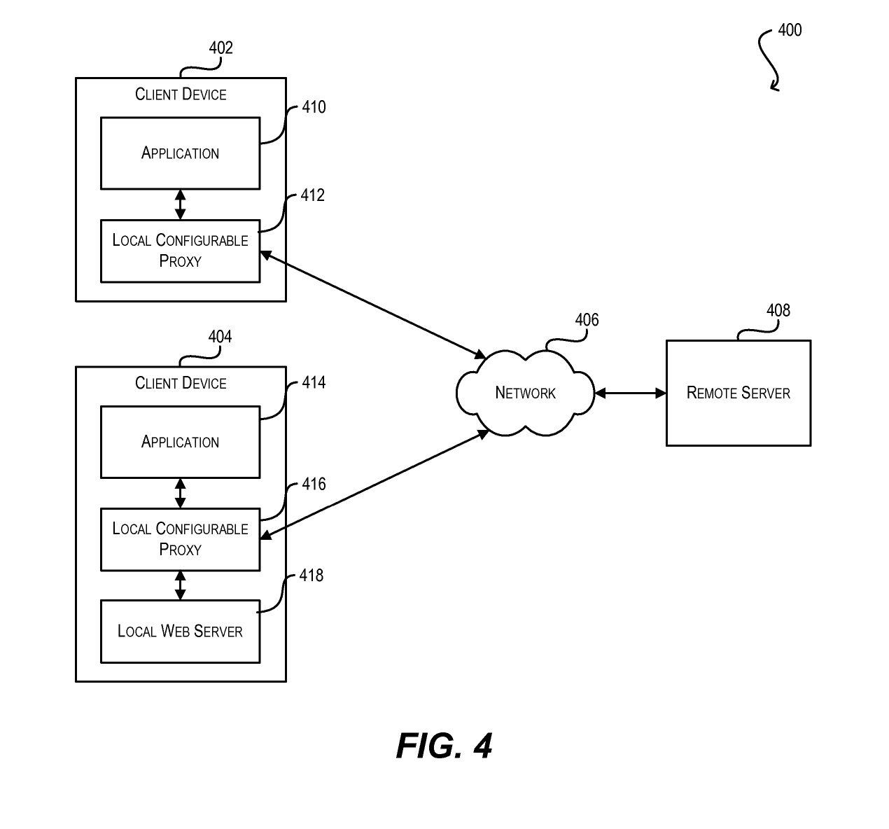

FIG. 4 is a simplified block diagram of an exemplary system environment 400 that may be used in accordance with an embodiment of the present invention. System environment 400 includes client computing devices 402, 404, which are used to run client applications 410, 414 and local configurable proxies 412, 418. In various embodiments, proxies 412, 418 represent instances of proxy cache 300 illustrated in FIG. 3. Computing devices 402, 404 may also run a local web server such as local web server 418. Computing devices 402, 404 may be, for example, a general purpose personal computer (including a personal computer and/or laptop computer running various versions of Microsoft Windows and/or Apple Macintosh operating systems), a handheld/mobile device such as a cell phone, PDA, or mobile PC (running software such as PalmOS and/or Microsoft Windows Mobile and being Internet, e-mail, SMS, Blackberry, or other communication protocol enabled), and/or a workstation computer running any of a variety of commercially-available UNIX or UNIX-like operating systems (including without limitation, the variety of GNU/Linux operating systems). Alternatively, computing devices 402, 404 may be any other electronic device capable of communicating via a network (e.g., network 406 described below) and/or running web-based applications. Although exemplary system environment 400 is shown with two computing devices, any number of computing devices may be supported.

As shown, local configurable proxies 412, 416 acts as intermediaries between client applications 410, 414 and remote server 408. Thus, client applications 410, 414 make data requests (perhaps unknowingly) through proxies 412, 416, which then forward the requests to server 408. As described in the foregoing disclosure, proxies 410, 414 are configured to provide a schedulable, offline mechanism for managing content updates for applications 410, 414 while the applications are not running.

In most embodiments, system environment 400 includes some type of network 406. Network 406 may be any type of network familiar to those skilled in the art that can support data communications using any of a variety of commercially-available protocols, including without limitation TCP/IP, SNA, IPX, AppleTalk, and the like. Merely by way of example, network 406 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks.

System environment 400 also includes one or more remote servers 408 which may be general purpose computers, specialized server computers (including, merely by way of example, PC servers, UNIX servers, mid-range servers, mainframe computers rack-mounted servers, etc.), server farms, server clusters, or any other appropriate arrangement and/or combination. In various embodiments, server 408 may act as a web server configured to respond to HTTP requests initiated by client applications 410,414 and/or proxies 412, 416.

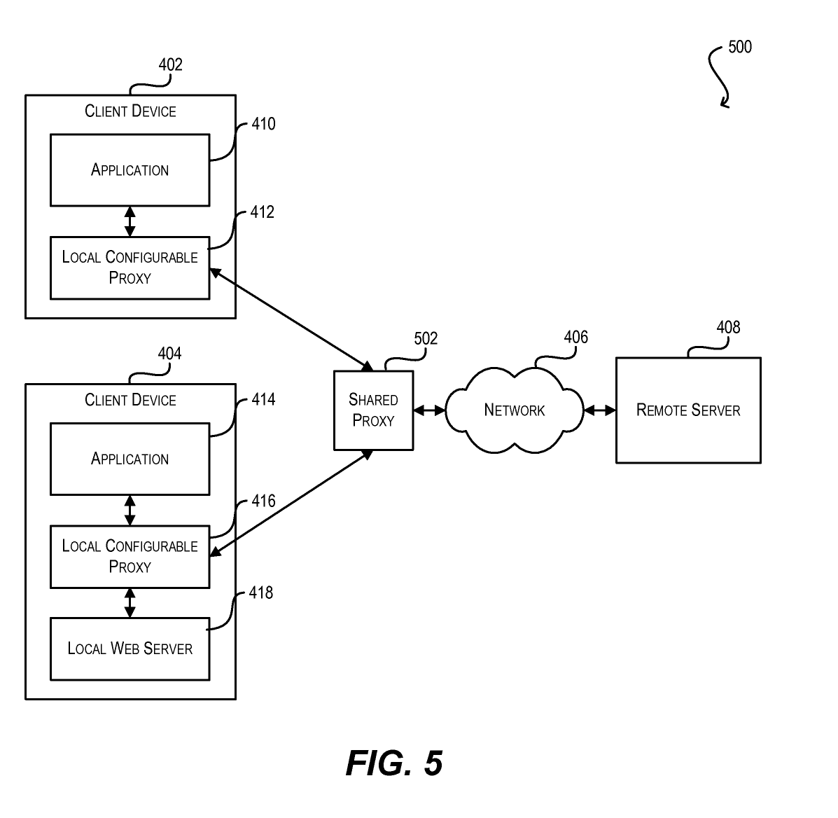

FIG. 5 is a simplified block diagram of another system environment 500 that may be used in accordance with an embodiment of the present invention. System environment 500 is similar to system environment 400 of FIG. 4, but includes a shared proxy 502. As shown, shared proxy 502 (which represents an instance of proxy cache 300 of FIG. 3), acts as an intermediary between local proxies 412, 416 and remote server 408. Thus, embodiments of the present invention may be used to service a plurality of devices.

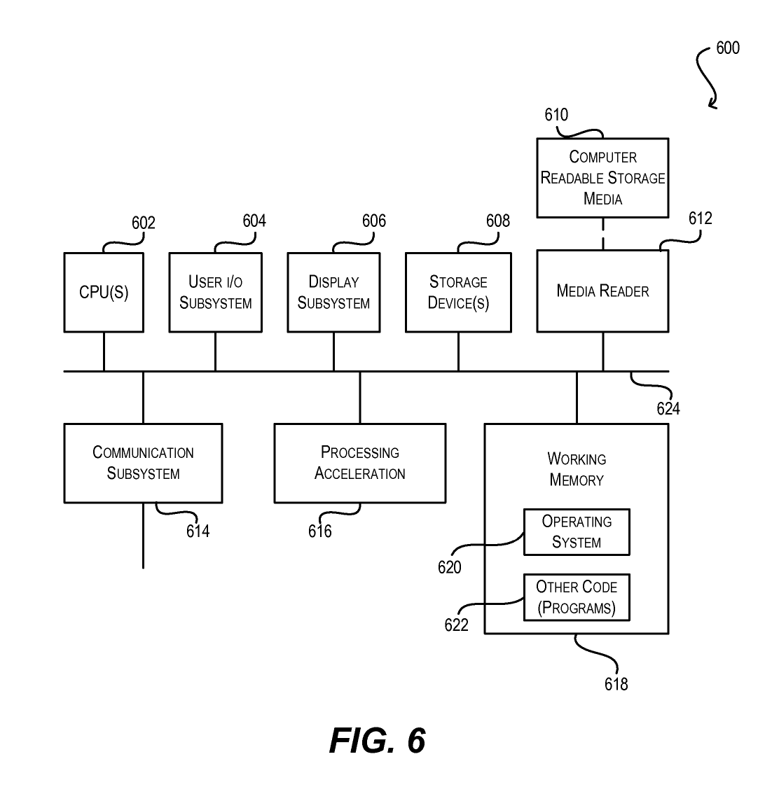

FIG. 6 illustrates an exemplary computing device 600 that may be used in accordance with an embodiment of the present invention. Computing device 600 may be used to implement any of the computer devices/systems illustrated in FIGS. 4 and 5. Computing device 600 is shown comprising hardware elements that may be electrically coupled via a bus 624. The hardware elements may include one or more central processing units (CPUs) 602, one or more input devices 604 (e.g., a touch-screen, a keyboard, a mouse, etc.), and one or more output devices 606 (e.g., a display, a printer, etc.). Computing device 600 may also include one or more storage devices 608. By way of example, the storage device(s) 608 may include devices such as disk drives, optical storage devices, solid-state storage device such as a random access memory (“RAM”) and/or a read-only memory (“ROM”), which can be programmable, flash-updateable and/or the like.

Computing device 600 may additionally include a computer-readable storage media reader 612, a communications system 614 (e.g., a modem, a network card (wireless or wired), an infra-red communication device, etc.), and working memory 618, which may include RAM and ROM devices as described above. In some embodiments, computing device 600 may also include a processing acceleration unit 616, which can include a digital signal processor DSP, a special-purpose processor, and/or the like.

The computer-readable storage media reader 612 can further be connected to a computer-readable storage medium 610, together (and, optionally, in combination with storage device(s) 608) comprehensively representing remote, local, fixed, and/or removable storage devices plus storage media for temporarily and/or more permanently containing computer-readable information. The communications system 614 may permit data to be exchanged with a network and/or any other computer. For example, computer system 600 may be part of a larger system/network environment including a plurality of interconnected computing devices.

Computing device 600 may also comprise software elements, shown as being currently located within a working memory 618, including an operating system 620 and/or other code 622, such as application 410 and local configurable proxy 412 of FIG. 4. It should be appreciated that alternative embodiments of computing device 600 may have numerous variations from that described above. For example, customized hardware might also be used and/or particular elements might be implemented in hardware, software, or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, one of ordinary skill in the art will appreciate other ways and/or methods to implement the various embodiments.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for managing content updates for an application, the method comprising:
receiving from the application a first request for data, wherein the first request includes one or more configuration parameters, and wherein the one or more configuration parameters define a schedule for retrieving the data from a remote server; and
retrieving the data from the remote server according to the schedule, wherein the step of retrieving is performed while the application is not running.

2. The method of claim 1, wherein retrieving the data from the remote server according to the schedule comprises:
forwarding, at a time indicated in the schedule, the first request to the remote server;
receiving the data from the remote server in response to the forwarding of the first request; and
storing the data in a cache.

3. The method of claim 2 further comprising:
receiving from the application a second request for the data; and
transmitting the data stored in the cache to the application in response to the second request.

4. The method of claim 2, wherein the one or more configuration parameters include a history parameter defining a maximum number of versions of the data that may be stored in the cache simultaneously.

5. The method of claim 1, wherein the one or more configuration parameters include a time interval parameter defining a time interval at which the data is to be retrieved from the remote server.

6. The method of claim 1, wherein the one or more configuration parameters include a retry parameter defining a number of times to retry a connection to the remote server.

7. The method of claim 1, wherein the one or more configuration parameters include a notification parameter indicating that a notification should be transmitted to the application upon occurrence of an event.

8. The method of claim 7, wherein the event corresponds to a detection of a new email.

9. The method of claim 1, wherein the application is a web browser.

10. The method of claim 1, wherein the first request is an HTTP request, and wherein the one or more configuration parameters correspond to one or more HTTP headers.

11. A method for managing content updates for an application, the method comprising:
receiving from the application a first request for data, wherein the first request includes an identifier that uniquely identifies the first request;
forwarding the first request to a remote server;
receiving the data from the remote server in response to the forwarding the first request;
storing the received data and the unique identifier in a cache;
receiving from the application a second request for the data, wherein the second request includes the identifier;
retrieving the data from the cache using the identifier; and
transmitting the data retrieved from the cache to the application.

12. A configurable proxy comprising:
a request processing component configured to:
receive, from a client application, a request for data; and
detect the presence of one or more proxy configuration parameters within the request;
a rules component configured to:
determine a schedule for retrieving the requested data from a remote server based on the one or more proxy configuration parameters; and
repeatedly forward the request to the remote server according to the determined schedule without further requests from the client application; and
a data storage component configured to cache data received from the remote server for later transmission to the client application.

13. The configurable proxy of claim 12, wherein the request is an HTTP request, and wherein the one or more proxy configuration parameters correspond to one or more HTTP headers.

14. The configurable proxy of claim 12, wherein the configurable proxy is implemented as a software application running on a handheld device.

15. A system for managing content updates, the system comprising:
a first computing device configured to execute a first client application and a first proxy application, the first proxy application being configured to:
receive, from the first client application, a first request for first data, wherein the first request includes one or more configuration parameters, and wherein the one or more configuration parameters define a first schedule for retrieving the first data from a remote server; and
retrieve the first data from the remote server according to the first schedule, wherein the step of retrieving is performed while the first client application is not running.

16. The system of claim 15 further comprising:
a second computing device configured to execute a second client application and a second proxy application, the second proxy application being configured to:
receive, from the second client application, a second request for second data, wherein the second request includes one or more configuration parameters, and wherein the one or more configuration parameters define a second schedule for retrieving the second data from the remote server; and
retrieve the second data from the remote server according to the second schedule, wherein the step of retrieving is performed while the second client application is not running; and
a third computing device communicatively coupled with the first and second computing devices, wherein the third computing device is configured to execute a shared proxy application, and wherein the first and second proxy applications are configured to access the remote server through the shared proxy application.

17. The system of claim 15, wherein retrieving the first data from the remote server according to the first schedule comprises:
forwarding, at a time indicated in the first schedule, the first request to the remote server;
receiving the first data from the remote server in response to the forwarding of the first request; and
storing the first data in a cache.

18. The system of claim 17, wherein the first proxy application is further configured to:
receive a second request for the first data from the first client application; and
transmit the first data stored in the cache to the first client application in response to the second request.

19. The system of claim 15, wherein the first request is an HTTP request, and wherein the one or more configuration parameters correspond to one or more HTTP headers.

20. The system of claim 15, wherein the first computing device is a handheld device.

21. A machine-readable medium for a computer system, the machine-readable medium having stored thereon a series of instructions which, when executed by a processing component, cause the processing component to:
receive from an application a first request for data, wherein the first request includes one or more configuration parameters, and wherein the one or more configuration parameters define a schedule for retrieving the data from a remote server; and
retrieve the data from the remote server according to the schedule, wherein the step of retrieving is performed while the application is not running.

22. The machine-readable medium of claim 21, wherein retrieving the data from the remote server according to the schedule comprises:
forwarding, at a time indicated in the schedule, the first request to the remote server;
receiving the data from the remote server in response to the forwarding of the first request; and
storing the data in a cache.

23. The machine-readable medium of claim 21 further having instructions that cause the processing component to:
receive from the application a second request for the data; and
transmit the data stored in the cache to the application in response to the second request.

24. The machine-readable medium of claim 21, wherein the first request is an HTTP request, and wherein the one or more configuration parameters correspond to one or more HTTP headers.
